(19) United States
(12) Patent Application Publication
(10) Pub. No.: US 2020/0063978 A1
(43) Pub. Date: Feb. 27, 2020

(54) COOKING DEVICE COMPRISING A REMOVABLE SENSOR MODULE

(71) Applicant: BSH Hausgeräte GmbH, Munich (DE)

(72) Inventors: Sebastian Erbe, Knittlingen-Freudenstein (DE); Arnulf Himmel, Traunreut (DE); Dan Neumayer, Bernau (DE)

(21) Appl. No.: 16/487,455

(22) PCT Filed: Feb. 9, 2018
(86) PCT No.: PCT/EP2018/053277

§ 371 Date: Aug. 21, 2019

(30) Foreign Application Priority Data
Feb. 21, 2017 (DE) 10 2017 202 773.8

(51) Int. Cl. F24C 7/08; H04N 5/225

(52) U.S. Cl. CPC F24C 7/085; F24C 15/04; H04N 5/2252

(57) ABSTRACT

A cooking device, in particular an oven, includes a cooking chamber for cooking a product, and an optical sensor module which is configured to detect a property of the product. The sensor module can be reversibly removed. The sensor module includes a sensor such as an optical sensor, an NIR sensor, or a pyrometer

The invention relates to a cooking device having a cooking chamber for cooking a product according to the preamble of claim 1.

Document DE102007048834A1 discloses a cooking device having a camera for viewing the product. The disadvantage of this solution is that the camera is exposed to the high temperatures of the oven. Accordingly the maximum temperature of the oven is essentially limited to the maximum temperature of the camera, meaning that operating modes called for by the user, e.g. hot air at 300° C. for pizza or pyrolytic self-cleaning at 500° C., are not possible.

The object of the invention is to improve the operation of sensors in the product, in particular to arrange the sensor securely in the cooking device such that it satisfies the user requirements for a cooking device, e.g. pyrolytic self-cleaning, along with the environmental requirements for sensors, e.g. maximum temperature, and ensures them across all operating modes.

The invention is based on a cooking device, in particular an oven, having a cooking chamber for cooking a product and an optical sensor module for detecting properties of the product. A cooking device should in particular be understood as an oven, a microwave device, or a steam cooker which is suitable for cooking a product, e.g. food for consumption, sufficiently. An optical sensor module should in particular be understood as an electronic component which is designed for detecting properties and states of the product by means of sensors.

It is proposed that the sensor module can be reversibly removed. “Can be reversibly removed” should in particular be understood to mean that the sensor module can be removed without tools for the end customer such that it can be removed non-destructively from the cooking device and can be reintroduced into the original situation. This design configuration enables the cooking device to be operated with a sensor module deployed in the range of cooking temperatures that are below critical operating temperatures of the sensor module and at the same time enables the cooking device to be operated with the sensor module removed at cooking chamber temperatures that are above the critical temperatures of the sensor module. Thus it is possible to detect the properties of a product during temperature-critical temperatures of the cooking device and to remove the sensor module at higher temperatures, e.g. during pyrolytic self-cleaning of the cooking device.

Preferably the sensor module has at least one sensor, which is preferably an optical sensor, in particular a camera, an NIR sensor and/or a pyrometer. Such optical sensors are particularly suitable for detecting properties and states of the product, wherein the camera can record images, an NIR sensor can detect the category of food or a pyrometer can determine the temperature.

Preferably the sensor is designed to record data, preferably visual information, temperature information or information about the composition of the product. This mostly digital data enables the property of the product to be analyzed.

Preferably the sensor module has at least one electronics unit for processing data from the sensor. An electronics unit should preferably be understood as a data processing device which comprises the software necessary for operating the sensor, and moreover can further process the data obtained by the sensor.

Preferably the sensor module has a data transmission apparatus for transmitting data from the sensor and/or the electronics unit. A data transmission apparatus should in particular be understood as a system which is designed to transmit the data obtained by the sensor to another, preferably external, system.

Preferably the data transmission apparatus transmits data to the cooking device and/or an external receiver, in particular a router or a mobile terminal.

Preferably the data transmission apparatus features corded and/or cordless transmission. The data obtained by the sensor can thus either be sent via a cable arranged on the sensor module e.g. a d-bus, or via cordless transmission, e.g. by means of Bluetooth or WLAN, to a receiver which further processes the data obtained.

Preferably the sensor module has an electrical power supply, preferably a power storage system, in particular a battery or a capacitor. To safeguard the electrical power supply of the sensor module, the sensor module has a power storage system which supplies the sensor and the further components with sufficient power, in particular current.

Preferably the sensor module has a housing in which are arranged at least the sensor, the data transmission apparatus and the power supply. The housing houses the components of the sensor module such that they are sufficiently well protected against environmental influences, e.g. heat or dirt.

Preferably the sensor module, preferably the housing, has a grip element or a holding section. By attaching a grip element or a holding section to the housing it should be possible to ensure that the sensor module can easily be removed from the cooking device, wherein this can be done without tools in a manner that is convenient for the user.

Preferably the sensor module has at least one apparatus for cooling temperature-critical components of the sensor module. Temperature-critical components should in particular be understood as components of the sensor module which in respect of their maximum operating temperature lie below the temperature of the cooking device in the cooking mode. Such an apparatus should ensure that the sensor module is sufficiently protected against overheating. Such an apparatus can for example be formed from a fan which by means of a generated air flow supplies the sensor module with sufficiently cool air and prevents what is known as accumulated heat. As an alternative to additional ventilation, recourse can also be had to the ventilation apparatus of the cooking device, which for example ventilates the door of the cooking device.

Preferably the sensor module is arranged in the effective range of an active cooling system of the cooking device, wherein the cooling system is explicitly provided for the sensor module. Alternatively an already existing cooling system for the cooking device is used. An active cooling system should in particular be understood as an apparatus that generates cold, which preferably helps to reduce the heat by means of a compressor or absorption technology.

Further features of the invention emerge from the figures and the description of the figures. The features and combinations of features mentioned above in the description and the features and combinations of features mentioned below in the description of the figures and/or merely shown in the figures may be used not only in the combination indicated in each case but also in other combinations or alone, without going beyond the scope of the invention. Exemplary embodiments of the invention which are not explicitly shown in the schematic figures and described, but which arise and can be created through separate combinations of features from the embodiments described are therefore also to be considered as included and disclosed. In the drawings:

FIG. 1 shows a schematic perspective illustration of a cooking device;

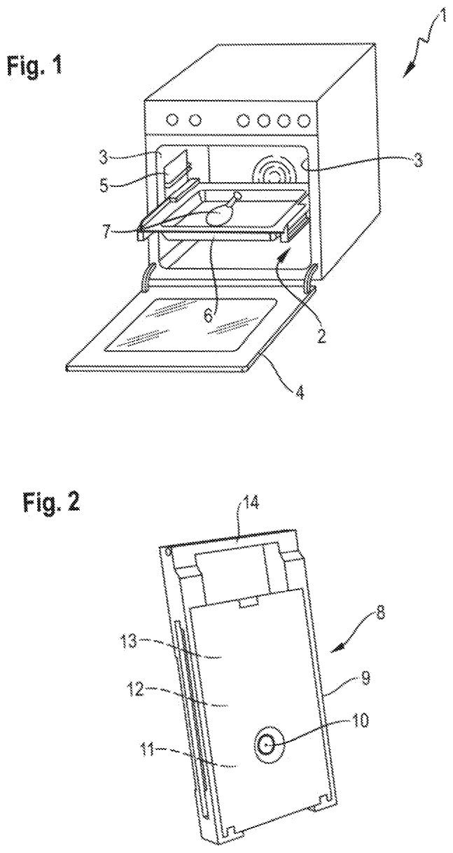

FIG. 2 shows a schematic perspective illustration of an inventive sensor module; and

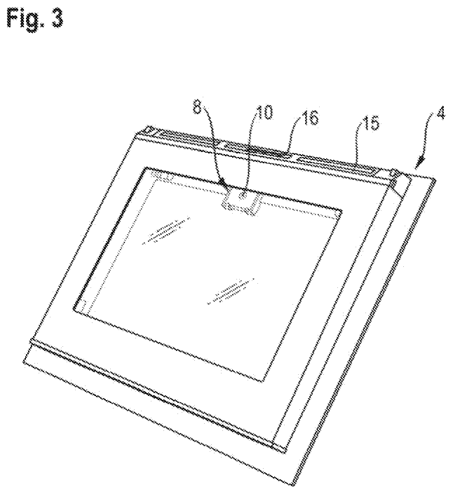

FIG. 3 shows a schematic perspective illustration of the sensor module in a preferred installation position.

In the drawings, the same or functionally identical elements are provided with the same reference characters.

FIG. 1 shows a perspective illustration of a cooking device 1 for preparing food, which in the exemplary embodiment is an oven. The cooking device 1 comprises a cooking chamber 2, which is bounded by side walls 3 of the cavity. At the front the cooking chamber 2 has a loading opening which can be closed by a door 4. Located on each of the side walls 3 is a side rail 5, which is suitable for accommodating product supports 6, e.g. shelves or baking trays, on which the product 7 to be cooked lies. A sensor module 8 is provided in the door 4 to detect properties of the product 7. This installation position has proved to be especially good, since it most closely approximates to the viewing angle familiar to the user into the cooking device 1 or onto the product 7. Moreover the interior glass pane of the door 4 is a good barrier in respect of the heat, but is nevertheless transparent for the sensor module 8.

FIG. 2 shows a perspective illustration of the sensor module 8 configured as a camera. The sensor module has a housing 9, wherein a sensor 10 arranged therein is arranged in the region of a cutout in the housing 9, in order to be able to view the product through this cutout. In the exemplary embodiment shown the sensor 10 is embodied as an optical sensor, in order to record visual information, in particular in the form of a digital image or a video stream. The visual information generated by the sensor 10 is processed by an electronics unit 11 which is likewise arranged in the housing 9 of the camera 8. Moreover the sensor module 8 has a data transmission apparatus 12 which is designed to transmit the visual information. The sensor module 8 moreover has an electrical power supply 13 which supplies the sensor module 8 and the elements located therein with power. The housing 9 has a grip element 14, with the aid of which the sensor module 8 can be removed from the cooking device 1. Thus the user of the cooking device 1 can remove the sensor module 8, in its installation position, from the cooking device, preferably from the door 4, without tools.

FIG. 3 shows the sensor module 8 in its installation position in the region of the door 4 of the cooking device 1. In this case the top panel 15 of the door 4 has a cutout 16 which is designed for securely fixing the sensor module 8 between the door panes of the door 4. The installation position of the sensor module 8 in the door 4 is selected such that the sensor 10 has an unobstructed view of the product 7.

For the person skilled in the art it is apparent that the invention is not restricted to the exemplary embodiment illustrated, but that it likewise includes a multiplicity of variants and modifications.

### LIST OF REFERENCE CHARACTERS

1 Cooking device, oven
2 Cooking chamber
3 Side wall

### 4 Door

5 Side rail
6 Product support

### 7 Product

8 Sensor module, camera

### 9 Housing

### 10 Sensor

11 Electronics unit
12 Data transmission apparatus
13 Electrical power supply
14 Grip element
15 Top panel

### 16 Cutout

1-14. (canceled)

15. A cooking device, comprising:
a cooking chamber for cooking a product; and
an optical sensor module configured to detect a property of the product, said sensor module being reversibly removable.

16. The cooking device of claim 15, constructed in the form of an oven.

17. The cooking device of claim 15, wherein the sensor module includes a sensor.

18. The cooking device of claim 17, wherein the sensor is a member selected from the group consisting of an optical sensor, an NIR sensor, and a pyrometer.

19. The cooking device of claim 18, wherein the optical sensor is a camera.

20. The cooking device of claim 17, wherein the sensor is configured to record data selected from the group consisting of visual information, temperature information, and information about a composition of the product.

21. The cooking device of claim 15, wherein the sensor module includes an electronics unit for processing data from the sensor.

22. The cooking device of claim 21, wherein the sensor module includes a data transmission apparatus configured to transmit data from at least one of the sensor and the electronics unit.

23. The cooking device of claim 22, wherein the data transmission apparatus transmits the data to the cooking device and/or an external receiver.

24. The cooking device of claim 23, wherein the external receiver is a router or a mobile terminal.

25. The cooking device of claim 22, wherein the data transmission apparatus includes a corded and/or cordless transmission.

26. The cooking device of claim 15, wherein the sensor module includes an electrical power supply.

27. The cooking device of claim 26, wherein the electrical power supply is a power storage system.

28. The cooking device of claim 27, wherein the power storage system is a battery or a capacitor.

29. The cooking device of claim 15, wherein the sensor module includes a housing, a data transmission apparatus configured to transmit data at least from the sensor, and an electrical power supply, said housing being configured to accommodate the sensor, the data transmission apparatus and the power supply.

30. The cooking device of claim 15, wherein the sensor module includes a housing having a grip element or a holding section.

31. The cooking device of claim 15, wherein the sensor module includes a device for cooling a temperature-critical component of the sensor module.

32. The cooking device of claim 15, wherein the sensor module is arranged in an effective range of a cooling system of the cooking device.

33. The cooking device of claim 15, further comprising a door for closing the cooking chamber, said sensor module being arranged in an installation position on the door.

34. The cooking device of claim 15, wherein the sensor module is arranged in an installation position in a region surrounding the cooking chamber and including an opening for detecting a property of the product.
